(19) United States
(12) Patent Application Publication
(10) Pub. No.: US 2026/0321971 A1
(43) Pub. Date: Oct. 15, 2026

(54) ANTENNA DEVICE

(71) Applicant: YOKOWO CO., LTD., Tokyo (JP)

(72) Inventors: Noritaka TERASHITA, Tomioka-Shi, Gunma (JP); Takashi NOZAKI, Tomioka-Shi, Gunma (JP)

(73) Assignee: YOKOWO CO., LTD., Tokyo (JP)

(21) Appl. No.: 19/100,432

(22) PCT Filed: Oct. 27, 2022
(86) PCT No.: PCT/JP2022/040101

§ 371 Date: Jan. 31, 2025

Related U.S. Application Data
(60) Provisional application No. 63/394,102, filed on Aug. 1, 2022.

(51) Int. Cl. H01Q 1/52; H01Q 1/22; H01Q 1/32

(52) U.S. Cl. CPC H01Q 1/521; H01Q 1/22; H01Q 1/32

(57) ABSTRACT

An antenna device, includes: a first ground portion located on an upper side with respect to an inclined portion that is inclined with respect to a horizontal plane; a first antenna that is arranged on a front surface side of the first ground portion, and that supports a first frequency band of ground waves; a second ground portion that is located on the upper side with respect to the inclined portion, and that has a front surface parallel to the horizontal plane; and a second antenna that is arranged on a front surface side of the second ground portion, and that supports a second frequency band of satellite waves, the first ground portion and the first antenna being located on a lower side with respect to the second ground portion.

### TECHNICAL FIELD

The present disclosure relates to an antenna device.

### BACKGROUND ART

Patent Literature 1 describes an antenna arranged at an inclined portion in a vehicle.

### CITATION LIST

### Patent Literature

[PTL 1] Japanese Patent Application Publication No. 2009-272821

### SUMMARY OF INVENTION

### Technical Problem

When a plurality of antennas are arranged at an inclined portion, it was difficult to arrange the antennas efficiently within a limited accommodation space while ensuring desired characteristics with respect to each of the antennas.

The present disclosure is directed, for example, to efficiently arranging a plurality of antennas in an inclined portion within a limited accommodation space while ensuring desired characteristics with respect to each of the antennas. The present disclosure is directed also to others that will become apparent from the present description.

### Solution to Problem

An aspect of the present disclosure is an antenna device, comprising: a first ground portion located on an upper side with respect to an inclined portion that is inclined with respect to a horizontal plane; a first antenna that is arranged on a front surface side of the first ground portion, and that supports a first frequency band of ground waves; a second ground portion that is located on the upper side with respect to the inclined portion, and that has a front surface parallel to the horizontal plane; and a second antenna that is arranged on a front surface side of the second ground portion, and that supports a second frequency band of satellite waves, the first ground portion and the first antenna being located on a lower side with respect to the second ground portion.

According to an aspect described above of the present disclosure, each of a plurality of antennas can be efficiently arranged at an inclined portion within a limited accommodation space while ensuring desired characteristics.

### BRIEF DESCRIPTION OF DRAWINGS

FIG. 1 is a perspective view illustrating a mobile body M at which an antenna device 100 is to be arranged.

FIG. 2A is an explanatory diagram illustrating an antenna device of an embodiment of the present disclosure.

FIG. 2B is a plan view illustrating a second antenna 21.

FIG. 3 is an explanatory diagram illustrating an antenna device 100A of a comparative example.

FIG. 4 is an explanatory diagram illustrating an antenna device 100B of a first reference example.

FIG. 5 is a diagram illustrating the VSWR frequency characteristics of a first antenna 11 and a first antenna 11B.

FIG. 6 is an explanatory diagram illustrating an antenna device 100C of a first modified example.

FIG. 7 is an explanatory diagram illustrating an antenna device 100D of a second modified example.

FIG. 8 is an explanatory diagram illustrating an antenna device 100E of a third modified example.

FIG. 9 is an explanatory diagram illustrating an antenna device 100F of a fourth modified example.

FIG. 10A is an explanatory diagram illustrating an antenna device 100G of a second reference example.

FIG. 10B is a plan view illustrating an antenna device 100G.

FIG. 11A is an explanatory diagram illustrating an antenna device 100H of a fifth modified example.

FIG. 11B is an explanatory diagram illustrating an antenna device 100I of a sixth modified example.

FIG. 12 is a diagram illustrating the frequency characteristics of the average gain of a second antenna 21G in a second reference example.

FIG. 13 is a diagram illustrating the frequency characteristics of the average gain of a second antenna 21H in a fifth modified example.

FIG. 14 is a diagram illustrating the frequency characteristics of the average gain of a second antenna 21I in a sixth modified example.

FIG. 15A is an explanatory diagram illustrating an antenna device 100J of a seventh modified example.

FIG. 15B is an explanatory diagram illustrating an antenna device 100K of an eighth modified example.

FIG. 16 is a diagram illustrating the frequency characteristics of the average gain of a third antenna 31J and a third antenna 31K.

FIG. 17 is an explanatory diagram illustrating an antenna device 100L of a ninth modified example.

FIG. 18 is an explanatory diagram illustrating an antenna device 100M of a tenth modified example.

### DESCRIPTION OF EMBODIMENTS

At least following matters will become apparent from the present description and the accompanying drawings.

Hereinafter, preferred embodiments of the present disclosure will be described with reference to the drawings. The same or equivalent components, members, and the like illustrated in the drawings are given the same reference numerals, and an overlapping description is omitted as appropriate.

### Embodiments

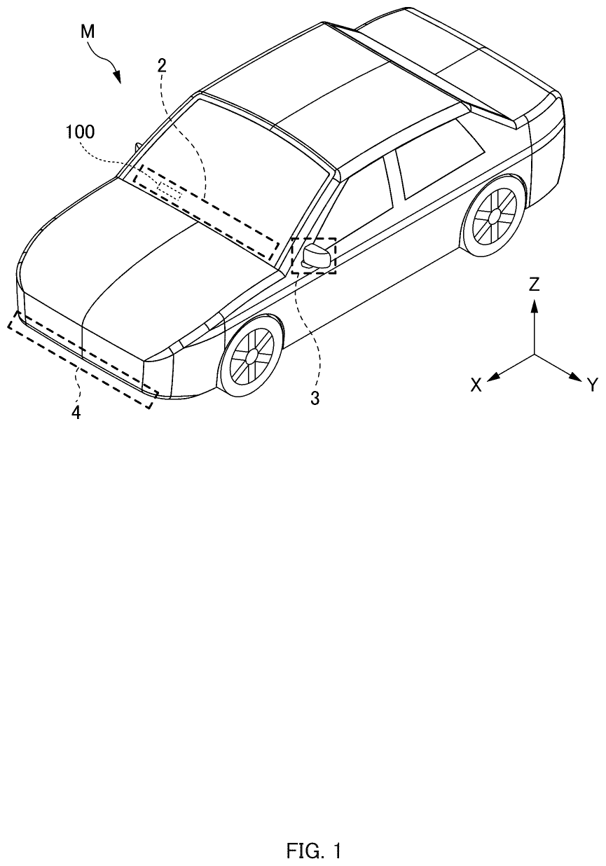

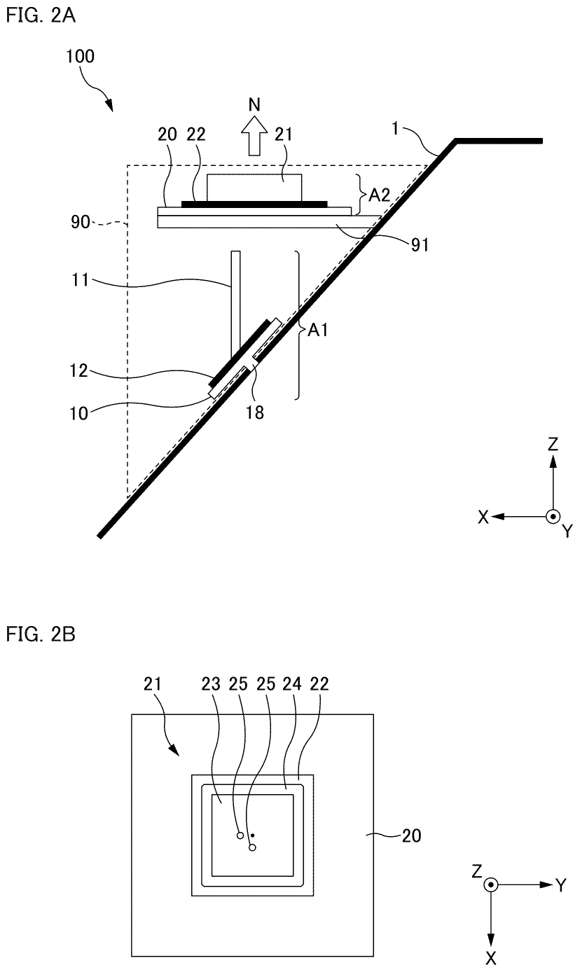

FIG. 1 is a perspective view illustrating a mobile body M at which an antenna device 100 is to be arranged. FIG. 2A is an explanatory diagram illustrating the antenna device 100 of an embodiment of the present disclosure. FIG. 2B is a plan view of a second antenna 21.

### Definition of Directions and the Like

First, directions (X direction, Y direction, and Z direction) and the like in the antenna device 100 are defined, with reference to FIGS. 1, 2A, and 2B.

The forward direction as seen from the driver's seat of the mobile body M (vehicle in an embodiment of the present disclosure) at which the antenna device 100 is arranged is defined as a +X direction (forward direction) of the antenna device 100. Further, the leftward direction as seen from the driver's seat of the mobile body M is defined as a +Y direction (leftward direction) of the antenna device 100, and the upward direction (zenith direction) as seen from the driver's seat of the mobile body M is defined as a +Z direction (upward direction) of the antenna device 100. Directions opposite to the +X direction, the +Y direction, and the +Z direction are defined as a −X direction (rearward direction), a −Y direction (rightward direction), and a −Z direction (downward direction), respectively. The +X direction, the −X direction, the +Y direction, the −Y direction, the +Z direction, and the −Z direction each have a fixed orientation.

When such a direction described above is not a fixed orientation, but indicates both the +X direction (forward direction) and −X direction (rearward direction), the direction may be simply referred to as “X direction” or “front-rear direction”. Similarly, when a direction indicates both the +Y direction (leftward direction) and −Y direction (rightward direction), the direction may be simply referred to as “Y direction” or “left-right direction”. Further, when a direction indicates both the +Z direction (upward direction) and the −Z direction (downward direction), the direction may be simply referred to as “Z direction” or “up-down direction”.

Further, an XY plane (a plane including both an axis extending along the X direction and an axis extending along the Y direction) may be referred to as “horizontal plane” because it is a plane perpendicular to the zenith direction. A direction parallel to the XY plane may be referred to as “horizontal direction”.

In FIGS. 1, 2A, and 2B, in order to facilitate the understanding of the directions and the like of the antenna device 100, the +X direction (forward direction), +Y direction (leftward direction), and +Z direction (upward direction) are each given by an arrowed line segment. The point of intersection between these arrowed line segments does not mean the coordinate origin. The front-rear direction or left-right direction may be referred to as “width direction”, and the up-down direction may be referred to as “height direction”.

The definitions of directions and the like described above are common to other embodiments in the present specification, unless otherwise specified.

### Overview of Antenna Device 10

Next, referring again to FIGS. 1, 2A, and 2B described above, an overview of the antenna device 100 of an embodiment of the present disclosure will be described.

The antenna device 100 is an antenna device to be arranged at the mobile body M, as illustrated in FIG. 1. Here, the term “mobile body” refers to a vehicle to move. In an embodiment of the present disclosure, the mobile body 1 is a vehicle. Here, the term “vehicle” refers to a wheeled vehicle. However, the mobile body M is not limited to the vehicle, and may be construction machinery, agricultural machinery, a vessel, a flight vehicle, a drone, and the like without a wheel. In the following explanation, the “mobile body” may be referred to as “vehicle”.

The antenna device 100 of an embodiment of the present disclosure is located at an instrument panel 2 of a vehicle, for example, as illustrated in FIG. 1. However, the antenna device 100 may be arranged at a side mirror 3 or a bumper 4 of the vehicle. Furthermore, the position in the vehicle at which the antenna device 100 is to be located is not limited to those positions described above, but can be changed as appropriate to one such as a spoiler, a roof, a hood, a pillar, or the like.

The antenna device 100 of an embodiment of the present disclosure is arranged at an inclined portion in the instrument panel 2, or the like of the vehicle as described above. Here, the term “inclined portion” refers to a portion that is inclined with respect to the horizontal plane (XY plane). The antenna device 100 may be located at any position of the vehicle, including the instrument panel 2 and the like, as described above, as long as it is an inclined portion.

FIG. 2A illustrates an example of the antenna device 100 located at an inclined portion 1 of the vehicle. A part of the inclined portion 1 at which the antenna device 100 is arranged is formed of a conductive material (conductive part). In other words, the inclined portion 1 includes a conductive part. However, the part of the surface where the antenna device 100 is arranged may be formed of an insulating member (e.g., resin, etc.). In other words, the inclined portion 1 does not have to include a conductive part.

The antenna device 100 includes a case 90, a first ground portion 10, a first antenna 11, a first base portion 12, a second ground portion 20, the second antenna 21, a second base portion 22, and a support portion 91. In the following explanation, the first ground portion 10, the first antenna 11, and the first base portion 12 may be referred to as “first antenna unit A1”. Further, the second ground portion 20, the second antenna 21, and the second base portion 22 may be referred to as “second antenna unit A2”.

### Case 90

The case 90 is a member forming the upper face of the antenna device 100. In the antenna device 100 of an embodiment of the present disclosure, the case 90 is made of insulating resin, for example. However, the case 90 may be made of another material that is other than insulating resin material and that allows radio waves to pass therethrough. The case 90 may include a part made of insulating resin and a part made of another material allowing radio waves to pass therethrough, and may include any combination of such members.

In an embodiment of the present disclosure, the case 90 is fixed to the inclined portion 1 with a screw (not illustrated). However, the case 90 is not limited to being fixed to the inclined portion 1 with a screw, and may be fixed thereto by snap fitting, welding, adhesion, and/or the like. The first antenna unit A1 and the second antenna unit A2 of the antenna device 100 are arranged in an accommodation space formed by the case 90 that constitutes the outer surface of the antenna device 100. The case 90 may be fixed to one other than the inclined portion 1, or the antenna device 100 does not have to include the case 90.

### Antenna Unit A1

The first ground portion 10 is a member that functions as a ground of the first antenna device 11. However, the first ground portion 10 may function as a ground common to the first antenna 11 and (an) other antenna(s) (not illustrated in FIG. 2A). In an embodiment of the present disclosure, the first ground portion 10 is formed as an integral metal plate (sheet metal) as illustrated in FIG. 2A, and is located on the upper side with respect to the inclined portion 1. However, the first ground portion 10 may be formed as multiple separate metal plates and be formed by electrically connecting these plates. Further, the first ground portion 10 is arranged parallel to the upper surface of the inclined portion 1 and is electrically connected to the inclined portion 1.

The first ground portion 10 may be formed in a shape other than a plate shape, as long as it is a member that functions as a ground of the first antenna 11. Further, the first ground portion 10 may be configured by freely combining a metal member and a member made of a material other than metal, as long as it functions as a ground of the first antenna 11. For example, the first ground portion 10 may have a metal plate and an insulator made of resin. Alternatively, the first ground portion 10 may be formed of a single substrate where a conductive pattern is formed at a printed-circuit board (PCB), or may be formed of a plurality of substrates.

The first antenna 11 is an antenna element that supports a frequency band of ground waves. The first antenna 11 may support radio waves in a frequency band for telephone (TEL) used for GSM, UMTS, LTE, 5G, and/or the like, or radio waves of a frequency band used for telematics, vehicle to everything (V2X) (vehicle-to-vehicle communication, road-to-vehicle communication), Wi-Fi, Bluetooth, and/or the like, for example. In addition, the first antenna 11 may support radio waves in the frequency band used for AM/FM radio and/or DAB, or may support radio waves in the frequency band used for a keyless entry antenna and/or a smart key antenna. The first antenna 11 only has to support radio waves in a desired frequency band in the frequency band of ground waves.

In an embodiment of the present disclosure, the first antenna 11 is a monopole antenna, as illustrated in FIG. 2A. However, the first antenna 11 may be of another antenna type, such as a dipole antenna, a loop antenna, a collinear antenna, a bowtie antenna, or the like. The first antenna 11 is arranged on the front surface side of the first ground portion 10 through the first base portion 12. Here, the “front surface” refers to the surface on the side where the antenna (here, the first antenna 11) is to be located.

The first base portion 12 is a member at which a feeding portion and a matching circuit of the first antenna 11 are located. The feeding portion of the first antenna 11 corresponds to a region including the feeding point of the first antenna 11. The first antenna 11 is connected to a coaxial cable (not illustrated) through the matching circuit at which the first base portion 12 is mounted. A circuit element and/or an electronic component other than the matching circuit, such as a connection detection circuit, an amplifier, a filter, and/or the like may be mounted at the first base portion 12.

The first base portion 12 is a substrate (circuit board). A conductive pattern (not illustrated), and an electronic component and/or a circuit element, such as the above-described matching circuit and the like, are mounted on the front surface side of the first base portion 12. Further, the first base portion 12 may be configured such that a conductive pattern is formed in a resin material using a molded interconnect device (MID) technique. The first base portion 12 is arranged parallel to the first ground portion 10, on the front surface side of the first ground portion 10. In other words, the first base portion 12 is arranged parallel to the upper surface of the inclined portion 1.

A contact surface of the first base portion 12 that is to contact the first ground portion 10 may be subjected to a conductive surface treatment such as solder leveling, gold plating, or gold flashing. This facilitates establishment of electrical connection between the first base portion 12 and the first ground portion 10.

### Second Antenna Unit A2 and Support Portion 91

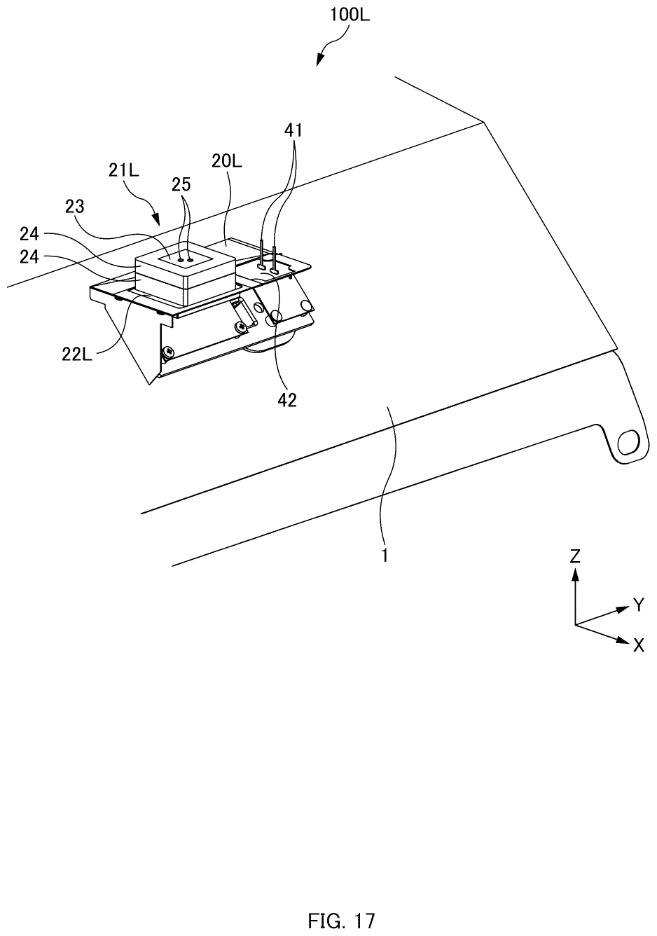

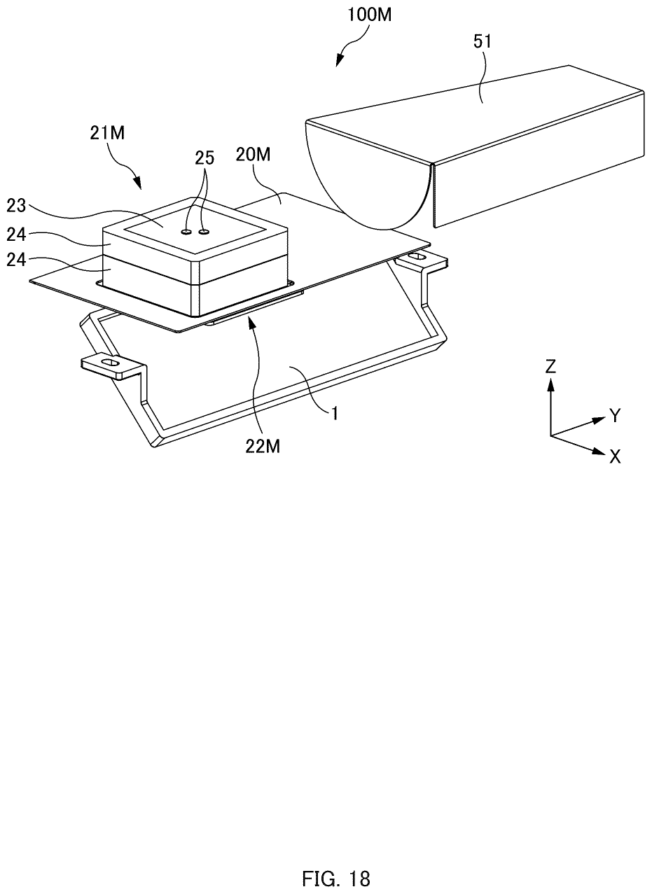

The second ground portion 20 is a member that functions as a ground of the second antenna 21. However, the second ground portion 20 may function as a ground common to the second antenna 21 and (an)other antenna(s) (not illustrated in FIG. 2A). An aspect of the antenna device including the ground common to the second antenna and (an) other antenna(s) will be described in detail in the explanation relating to an antenna device 100L illustrated in FIG. 17 and an antenna device 100M illustrated in FIG. 18.

In an embodiment of the present disclosure, the second ground portion 20 is formed as an integral metal plate (sheet metal) as illustrated in FIG. 2A, and located on the upper side with respect to the inclined portion 1. However, the second ground portion 20 may be formed as a plurality of separate metal plates and formed by electrically connecting these plates. The second ground portion 20 is supported by the support portion 91 (described below) made of an insulator. In other words, the second ground portion 20 is insulated from the inclined portion 1, and is supported with respect to the inclined portion 1. However, the second ground portion 20 may be supported with respect to the case 90 as will be described below.

The second ground portion 20 may be formed in a shape other than a plate shape, as long as it is a member that functions as a ground of the second antenna 21. The second ground portion 20 may be configured by freely combining a metal member and a member made of a material other than metal, as long as it functions as a ground of the second antenna 21. For example, the second ground portion 20 may have a metal plate and an insulator made of resin. The second ground portion 20 may be formed of a single substrate where a conductive pattern is formed at a printed-circuit board (PCB), or may be formed of a plurality of substrates.

As illustrated in FIG. 2B, the outer shape of the second ground portion 20 is a square with equal length and width in plan view when seen in the −Z direction (downward). However, the outer shape of the second ground portion 20 may be a quadrilateral shape other than a square, and may be, for example, a circular shape, an elliptical shape, a polygonal shape, or the like. Here, the term “quadrilateral” refers to a shape formed of four sides, and examples thereof include a square, a rectangle, a trapezoid, a parallelogram, and the like. In the “quadrilateral” shape, at least one of the corners may be cut off at an angle with respect to a side thereof. Further, the “quadrilateral” shape may have a cutout (recessed portion) or a protrusion (a protruding portion) formed in a part of a side thereof.

The second antenna 21 is an antenna that supports the frequency band of satellite waves. The second antenna 21 is a planar antenna (e.g., a patch antenna), and supports radio waves in the frequency band for global navigation satellite system (GNSS), for example. The second antenna 21 supports radio waves in a frequency band of the L1 band (1559 MHz to 1610 MHz frequency band), for example.

However, the communication standard and frequency band supported by the second antenna 21 are not limited to GNSS, and may be other communication standards and frequency bands. The second antenna 21 may support radio waves in the frequency band for satellite digital audio radio service (SDARS), for example. Further, the second antenna 21 may support desired circularly polarized waves, or may support desired linearly polarized waves, such as vertically polarized waves or horizontally polarized waves. The second antenna 21 only has to support radio waves in a desired frequency band in the frequency band of satellite waves. The second antenna 21 is arranged on the front surface side of the second ground portion 20 through the second base portion 22.

The second antenna 21 may be a so-called multi-band antenna that supports radio waves in multiple frequency bands. Specifically, the second antenna 21 may support radio waves in two frequency bands, which are the L1 band and the L5 band (1164 MHz to 1214 MHz band). Further, the frequency band of radio waves supported by the second antenna 21 may be, for example, a combination of two frequency bands, which are the L1 band and the L2 band (1212 MHz to 1254 MHz band), or a combination of three frequency bands, which are the L1 band, the L2 band, and the L5 band.

The target frequency in each of the L1 band, the L2 band, and the L5 band is, for example, the center frequency of the corresponding frequency band. Here, the center frequency of the L1 band is 1575.42 MHz, the center frequency of the L2 band is 1227.60 MHz, and the center frequency of the L5 band is 1176.45 MHz. In the second antenna 21, the shape of a radiating element 23, which will be described below, is designed based on the target frequency.

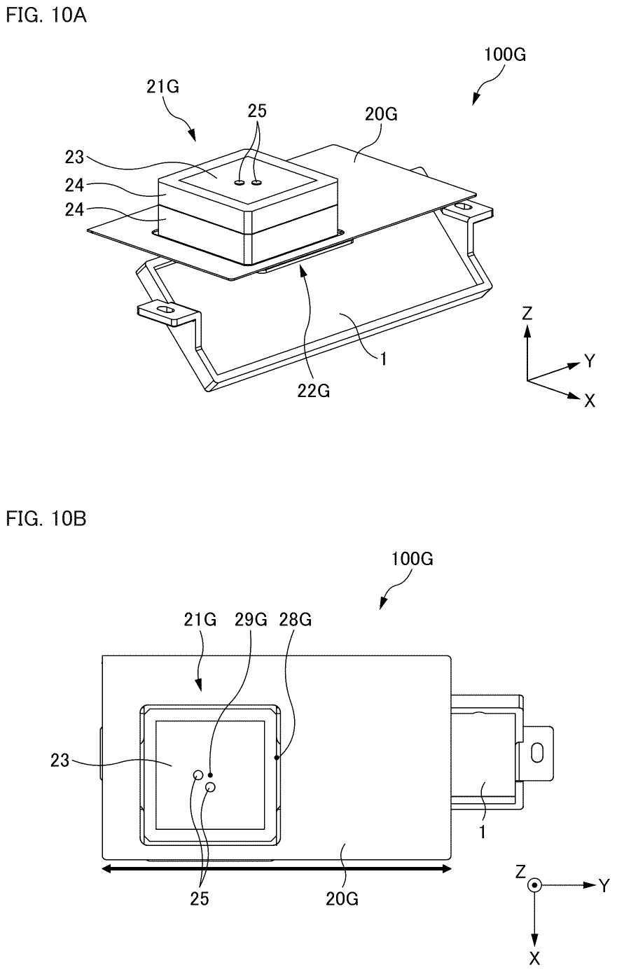

In order to support radio waves in multiple frequency bands, the antenna device 100 may be an antenna device of a so-called stacked patch antenna type in which multiple second antennas 21 supporting radio waves in frequency bands different from each other are stacked. For example, an antenna device 100G illustrated in FIG. 10A, which will be described bellow, is an antenna device of the stacked patch antenna type.

Furthermore, the frequency band of radio waves supported by the second antenna 21 may include an L band (1525 MHz to 1559 MHz band) and/or an L6 band (1273 MHz to 1284 MHz band) obtained by further combining a correction satellite signal, in addition to the L1 band, the L2 band, and the L5 band. Further, the frequency bands of radio waves supported by the second antenna 21 are not limited to the combination of the plurality of specific frequency bands described above, but may be a combination of a plurality of given frequency bands.

The second antenna 21 includes the radiating element 23 and a dielectric 24 as illustrated in FIG. 2B.

The radiating element 23 is a conductive member arranged at the dielectric 24. As illustrated in FIG. 2B, the outer shape of the radiating element 23 is a quadrilateral shape in plan view when seen in the −Z direction (downward). In an embodiment of the present disclosure, the outer shape of the radiating element 23 is a square with equal length and width. However, the outer shape of the radiating element 23 may be a rectangle with different length and width. Furthermore, the outer shape of the radiating element 23 is not limited to a quadrilateral shape, but may be a circular shape, an elliptical shape, a polygonal shape, or the like.

The radiating element 23 may have at least one of a slot or a cutout (slit) formed therein. For example, the frequency band of radio waves supported by the radiating element 23 with a slot (or slit) includes two frequency bands, one of which is determined by the outer shape dimensions of the radiating element 23 and the other of which is determined by the length of the slot (or slit) formed in the radiating element 23. This enables the second antenna 21 to support radio waves in a plurality of frequency bands, even if it is not of the stacked patch antenna type described above.

The radiating element 23 includes a feeding portion 25. The feeding portion 25 is a conductive part including a feeding point. The feeding point is a part at which the radiating element 23 is fed with a feed line (not illustrated). The second antenna 21 in an embodiment of the present disclosure employs a configuration including two feed lines (not illustrated) for feeding the radiating element 23, in other words, a double-feed system. Thus, in an embodiment of the present disclosure, the radiating element 23 has two feeding portions 25.

However, the feed system in the second antenna 21 is not limited to the double-feed system. The second antenna 21 may employ a quadruple-feed system, for example. In the second antenna 21 employing the quadruple-feed system, the radiating element 23 includes four feeding portions 25. Further, the second antenna 21 may employ a single-feed system, for example. In the second antenna 21 employing the single-feed system, the radiating element 23 includes one feeding portion 25.

The dielectric 24 is a member made of a dielectric material such as ceramic or the like. As illustrated in FIG. 2B, the outer shape of the dielectric 24 is a quadrilateral in plan view when seen in the −Z direction (downward). In an embodiment of the present disclosure, the outer shape of the dielectric 24 is a square with equal length and width. However, the outer shape of the dielectric 24 may be a rectangle with different length and width. Further, the outer shape of the dielectric 24 is not limited to a quadrilateral shape, but may be a circular shape, an elliptical shape, a polygonal shape, or the like. The radiating element 23 is arranged on the front surface side of the dielectric 24. A conductive pattern (not illustrated) that functions as a ground conductor film (or ground conductor plate) is formed on the back surface side of the dielectric 24. The dielectric 24 may be a dielectric substrate or may be a solid or hollow resin member.

The second base portion 22 is a member at which the dielectric 24 is arranged. In an embodiment of the present disclosure, the second base portion 22 is fixed to the second ground portion 20 by a screw (not illustrated), for example. However, the second base portion 22 may be supported by a seat portion that is formed by bending a part of the second ground portion 20 by bending process so as to protrude upward, and be fixed to the seat portion with a screw (not illustrated).

In an embodiment of the present disclosure, the second base portion 22 is arranged directly at the front surface of the second ground portion 20, as illustrated in FIG. 2A. In other words, the second base portion 22 is located at the front surface of the second ground portion 20 without any space therebetween. However, the second base portion 22 may be located above the front surface of the second ground portion 20 with a predetermined distance apart therefrom.

In an embodiment of the present disclosure, the second base portion 22 is a substrate (circuit board), and has a conductive pattern (not illustrated) formed on each of the front and back surface sides of the second base portion 22. A ground conductor plate (ground conductor film) of the second antenna 21 and a conductive pattern that functions as a ground of a circuit not illustrated are formed on the front surface side of the second base portion 22. A circuit pattern and/or a conductive pattern to which a signal line of a coaxial cable (not illustrated) is connected is formed on the back surface side of the second base portion 22. However, the conductive pattern formed at the second base portion 22 is not limited thereto, but may be different depending on the type of the second antenna 21. Further, the second base portion 22 may also be configured such that a conductive pattern is formed in a resin material using the MID technique.

The antenna device 100 may further include a shield case between the back surface of the second base portion 22 and the front surface of the second ground portion 20. The shield case is a member made of metal that electrically shields the mounted electronic component and/or the conductive pattern formed on the back surface side of the second base portion 22.

The support portion 91 is a member that supports the second ground portion 20 with respect to the inclined portion 1. In an embodiment of the present disclosure, the support portion 91 is, for example, a plate-shaped member as illustrated in FIG. 2A, and the second ground portion 20 is arranged on the front surface side thereof. The support portion 91 is arranged parallel to the horizontal plane (XY plane), and the second ground portion 20 is arranged on the front surface side of the support portion 91, such that the front surface of the second ground portion 20 is parallel to the horizontal plane. Here, the phrase “the front surface of the second ground portion 20 being parallel to the horizontal plane” is not limited to the front surface being strictly parallel thereto, but the front surface of the second ground portion 20 may be inclined at a predetermined angle with respect to the horizontal plane.

As illustrated in FIG. 2A, a storage space for the first antenna unit A1 is formed between the back surface side of the support portion 91 and the upper surface side of the inclined portion 1. This allows the first antenna unit A1 to be arranged on the lower side with respect to the second antenna unit A2. In other words, the first ground portion 10 and the first antenna 11 can be located on the lower side with respect to the second ground portion 20.

However, as long as the second ground portion 20 is supported such that the front surface thereof is parallel to the horizontal plane and the first ground portion 10 and the first antenna 11 can be located on the lower side with respect to the second ground portion 20, the support portion 91 does not have to be arranged parallel to the horizontal plane, and does not have to be formed in a plate shape. The support portion 91 may be formed as a part of the case 90, for example, such that the second ground portion 20 is supported with respect to the case 90. Further, as described above, the case 90 is fixed to the inclined portion 1. Accordingly, the second ground portion 20 may be supported with respect to the inclined portion 1. Further, since the second ground portion 20 is directly fixed to the inclined portion 1, the antenna device 100 does not have to include the support portion 91.

As described above, the outer shape of the second ground portion 20 is a square in plan view when seen in the −Z direction (downward) as illustrated in FIG. 2B. When the outer shape of the second ground portion 20 is a square as such, the gain and directivity in the zenith direction can be improved by arranging the second antenna 21 at the center of the second ground portion 20, as illustrated in FIG. 2B. The phrase “the second antenna 21 is arranged at the center of the second ground portion 20” specifically refers to that the center of the second antenna 21 is located at the center of the second ground portion 20. Here, the “center” refers to the geometric center of the outer shape.

In the antenna device 100 of an embodiment of the present disclosure, the support portion 91 is made of an insulator. If the second ground portion 20 were electrically connected to another conductor (here, the inclined portion 1), the part that appears to function as a ground would extend to the inclined portion 1, which might result in a deterioration of the gain and directivity of the second antenna 21 in the zenith direction. Accordingly, with the second ground portion 20 being arranged at the support portion 91 formed of an insulator (i.e., the second ground portion 20 being insulated from the inclined portion 1), it is possible to improve the gain and directivity of the second antenna 21 in the zenith direction.

### Characteristics of First Antenna 11 and Second Antenna 21 Arranged at Inclined Portion 1

In the antenna device 100 of an embodiment of the present disclosure, the first antenna 11 of the first antenna unit A1 and the second antenna 21 of the second antenna unit A2 can each be arranged at the inclined portion 1 so as to ensure the desired characteristics. The following describes, in detail, the respective characteristics of the second antenna 21 located on the upper side and the first antenna 11 located on the lower side, using a comparative example.

### Comparative Example

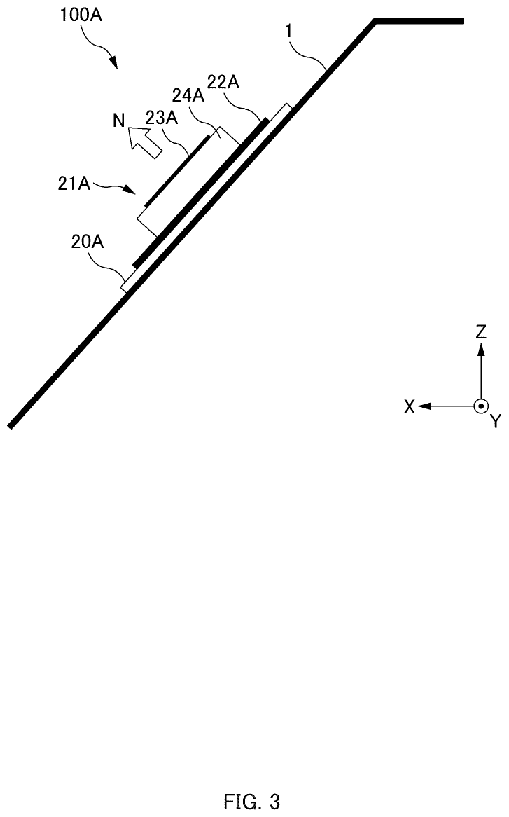

FIG. 3 is an explanatory diagram illustrating an antenna device 100A of the comparative example.

The antenna device 100A of the comparative example is arranged at the inclined portion 1, similarly to the antenna device 100 of an embodiment of the present disclosure. However, the antenna device 100A only includes a second ground portion 20A, a second antenna 21A, and a second base portion 22A, which correspond to the second antenna unit A2 of an embodiment of the present disclosure, without including a configuration corresponding to the first antenna unit A1 of an embodiment of the present disclosure.

In the antenna device 100A of the comparative example, the second ground portion 20A is also formed as an integral metal plate (sheet metal), as in an embodiment of the present disclosure, and is located on the upper side with respect to the inclined portion 1. However, the second ground portion 20A is arranged directly at the upper surface of the inclined portion 1, such that the front surface of the second ground portion 20A is parallel to the upper surface of the inclined portion 1. Further, with the second antenna 21A being arranged on the front surface side of the second ground portion 20 through the second base portion 22A, the front surface of the second antenna 21A (i.e., the front surface of the radiating element 23A of the second antenna 21A) results in being parallel to the upper surface of the inclined portion 1.

In an antenna that supports the frequency band of satellite waves, the gain the zenith direction (+Z direction) is important. An antenna that supports the frequency band of satellite waves can obtain the maximum gain in the zenith direction when the direction perpendicular to the front surface of the radiating element (the direction normal to the front surface) is directed to the zenith direction (Z direction). However, if the second ground portion 20A is arranged directly at the upper surface of the inclined portion 1, as in the antenna device 100A of the comparative example illustrated in FIG. 3, the front surface of the radiating element 23A results in being parallel to the inclined portion 1. Then, a direction N perpendicular to the front surface of the radiating element 23A (direction N normal to the front surface) results in being inclined with respect to the zenith direction (+Z direction). Accordingly, in the antenna device 100A of the comparative example, the gain in the zenith direction is degraded.

In contrast, in the antenna device 100 of an embodiment of the present disclosure, as illustrated in FIG. 2A, the front surface of the radiating element 23 is parallel to the horizontal plane (XY plane), which results in the direction N perpendicular to the front surface of the radiating element 23 (the direction N normal to the front surface) is directed to the zenith direction (in the +Z direction). Accordingly, in the antenna device 100 of an embodiment of the present disclosure, it is possible to suppress deterioration of the gain of the second antenna 21 in the zenith direction.

Furthermore, as described above, in the antenna device 100 of an embodiment of the present disclosure, with the second ground portion 20 being arranged such that the front surface of the radiating element 23 is parallel to the horizontal plane, a space is formed between the lower side of the second ground portion 20 and the inclined portion 1. The first antenna unit A1 (the first ground portion 10, the first antenna 11, and the first base portion 12) can be arranged in this space. Accordingly, the first antenna 11 of the first antenna unit A1 and the second antenna 21 of the second antenna unit A2 can each be efficiently arranged within the limited accommodation space (within the accommodation space formed by the case 90). In the antenna device 100 of an embodiment of the present disclosure, the first antenna 11 of the first antenna unit A1 and the second antenna 21 of the second antenna unit A2 can each be arranged at the inclined portion 1 so as to ensure desired characteristics.

### Configuration of Suppressing Unwanted Resonance

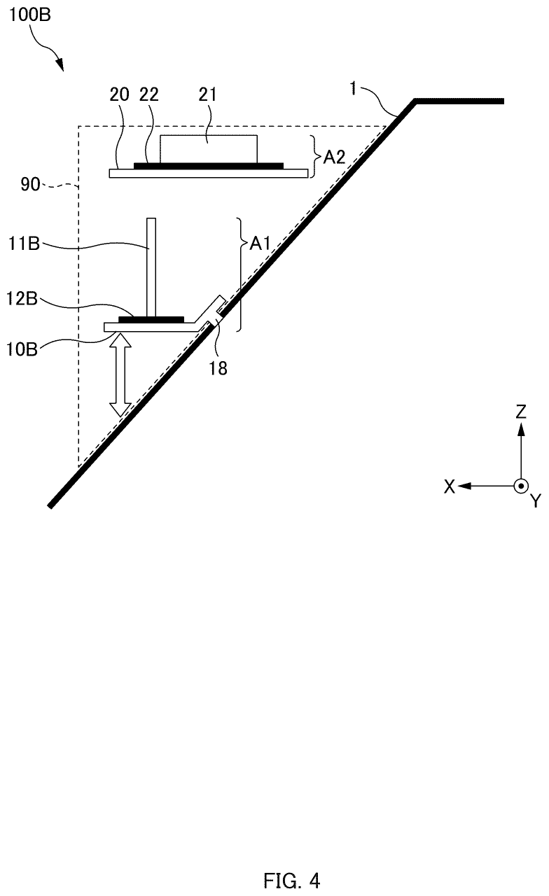

FIG. 4 is an explanatory diagram illustrating an antenna device 100B of a first reference example. In the following explanation, illustration and explanation of the support portion 91 are omitted. Further, explanation of the configuration that is the Same as that of the antenna device 100 of an embodiment of the present disclosure may be omitted.

The antenna device 100B of the first reference example is arranged at the inclined portion 1, as in the antenna device 100 of an embodiment of the present disclosure. The antenna device 100B includes: the case 90; a first ground portion 10B, a first antenna 11B and a first base portion 12B, which correspond to the first antenna unit A1; and the second ground portion 20, the second antenna 21 and the second base portion 22, which correspond to the second antenna unit A2.

The first ground portion 10B in the first reference example may be in an aspect different from that of the first ground portion 10 of an embodiment of the present disclosure. In other words, in the antenna device 100B of the first reference example, unlike the antenna device 100 of an embodiment of the present disclosure, the first ground portion 10B extends parallel to the horizontal plane (XY plane). However, the first ground portion 10B is not limited to an aspect of extending in the horizontal direction, but may extend to form a predetermined angle with the inclined portion 1. This makes it possible to form, below the first ground portion 10B, a space in which (an) other antenna(s), electronic component(s), and/or the like can be accommodated. However, in the antenna device 100B, the back surface of the first ground portion 10B and the upper surface of the inclined portion 1 are spaced apart on the −X direction side, and the distance between the back surface of the first ground portion 10B and the upper surface of the inclined portion 1 increases toward the −X direction (see a double headed arrow in FIG. 4).

The first ground portion 10B is electrically connected to the inclined portion 1 including a conductor, similarly to the first ground portion 10 in an embodiment of the present disclosure. Thus, with the back surface of the first ground portion 10B being separated from the upper surface of the inclined portion 1, a parasitic capacitance corresponding to the distance between the first ground portion 10B and the inclined portion 1, or the like, may occur. This parasitic capacitance and the inductance determined by the first ground portion 10B may cause unwanted resonance in the first ground portion 10B. In this event, unwanted resonance occurring at the first ground portion 10B may have an effect on the frequency band of radio waves supported by the first antenna 11B. Specifically, the gain of the first antenna 11B may decrease due to a deterioration of the desired frequency characteristics of the VSWR in the first antenna 11B.

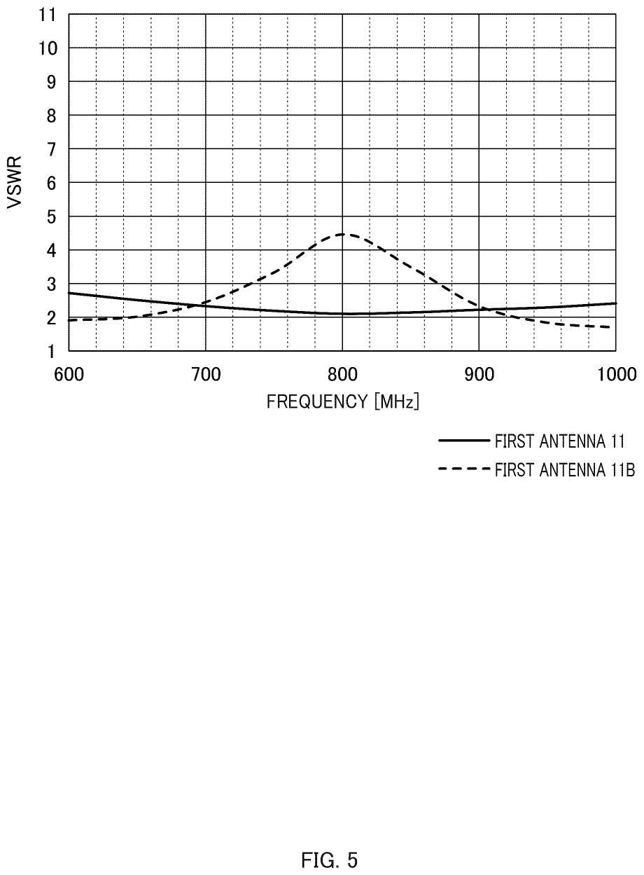

FIG. 5 is a diagram illustrating the VSWR frequency characteristics of the first antenna 11 and the first antenna 11B.

In FIG. 5, the horizontal axis represents frequency and the vertical axis represents voltage standing wave ratio (VSWR). The results of the first antenna 11 in an embodiment of the present disclosure described above are given by a solid line, and the results of the first antenna 11B of the first reference example are given by a dashed line.

As illustrated in FIG. 5, the VSWR in the first antenna 11 of an embodiment of the present disclosure is 3 or less in the frequency band of radio waves supported by the first antenna 11, which is a good result. In contrast, the VSWR of the first antenna 11B in the first reference example exceeds 3 at around 800 MHz, in the frequency band of radio waves supported by the first antenna 11B. In other words, it can be seen that the desired frequency characteristics of the VSWR of the first antenna 11B deteriorate. Accordingly, it can be seen that the gain of the first antenna 11B decreases lower than that of the first antenna 11.

In the antenna device 100 of an embodiment of the present disclosure, the first ground portion 10 is formed so as to suppress unwanted resonance in the frequency band of radio waves supported by the first antenna 11. Specifically, the first ground portion 10 is arranged parallel to the upper surface of the inclined portion 1 as illustrated in FIG. 2A.

This makes it possible, in the antenna device 100 of an embodiment of the present disclosure, to reduce the distance between the back surface of the first ground portion 10 and the upper surface of the inclined portion 1, and reduce the potential difference generated between the first ground portion 10 and the inclined portion 1 smaller than that in the first ground portion 10B. Accordingly, it is possible to lower the frequency of unwanted resonance caused by the parasitic capacitance between the first ground portion 10 and the inclined portion 1, as compared to the case of the first ground portion 10B, thereby being able to suppress the effect on the frequency band of radio waves supported by the first antenna 11, to suppress a reduction in the gain of the first antenna 11.

Note that the aspect of the first ground portion is not limited to the case illustrated in FIG. 2A, as long as the effect of unwanted resonance on the frequency band of radio waves supported by the first antenna can be suppressed.

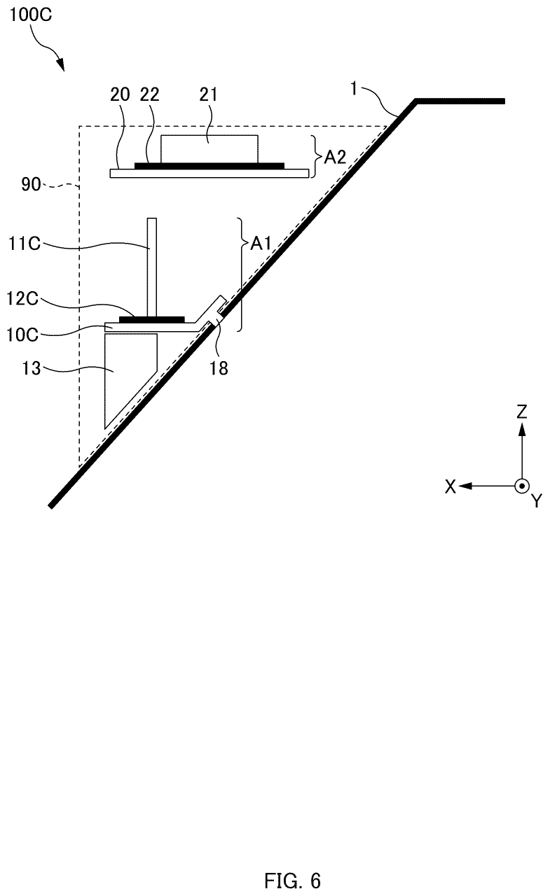

FIG. 6 is an explanatory diagram illustrating an antenna device 100C of a first modified example.

The antenna device 100C of the first modified example is arranged at the inclined portion 1, as in the antenna device 100 of an embodiment of the present disclosure. The antenna device 100C includes: the case 90; a first ground portion 10C, a first antenna 11C, and a first base portion 12C, which correspond to the first antenna unit A1; and the second ground portion 20, the second antenna 21, and the second base portion 22, which correspond to the second antenna unit A2.

The first ground portion 10C extends so as to form a predetermined angle with the inclined portion 1, as in the first ground portion 10B in the first reference example described above. Specifically, the first ground portion 10C extends parallel to the horizontal plane (XY plane). However, the first ground portion 10C is different from the first ground portion 10B in the first reference example in that the first ground portion 10C further includes a suppression portion 13 on the back surface side thereof

The suppression portion 13 is a member to suppress unnecessary resonance in the frequency band of radio waves supported by the first antenna 11C. The suppression portion 13 is a conductive member, and is formed of, for example, a conductive leaf spring, a gasket obtained by wrapping a conductive cloth around a cushion that is formed of a dielectric, or the like.

With the antenna device 100C of the first modified example including the suppression portion 13 on the back side of the first ground portion 10C, it is possible to reduce the distance between the back surface of the suppression portion 13 of the first ground portion 10C and the upper surface of the inclined portion 1. This makes it possible to reduce the potential difference generated between the first ground portion 10C and the inclined portion 1 smaller than that in the case of the first ground portion 10B. Accordingly, it is possible to lower the frequency of unwanted resonance caused by the parasitic capacitance between the first ground portion 10C and the inclined portion 1, as compared to the case of the first ground portion 10B, thereby being able to suppress the effect on the frequency band of radio waves supported by the first antenna 11C, and suppress a reduction in the gain of the first antenna 11C.

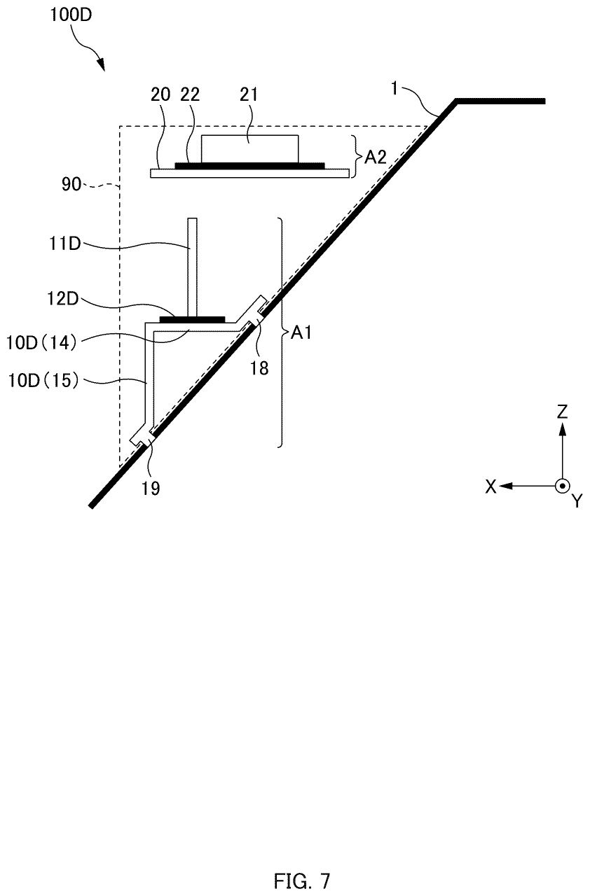

FIG. 7 is an explanatory diagram illustrating an antenna device 100D of a second modified example.

The antenna device 100D of the second modified example is arranged at the inclined portion 1, as in the antenna device 100 of an embodiment of the present disclosure. The antenna device 100D includes: the case 90, a first ground portion 10D, a first antenna 11D, and a first base portion 12D, which correspond to the first antenna unit A1; and the second ground portion 20, the second antenna 21, and the second base portion 22, which correspond to the second antenna unit A2.

The first ground portion 10D includes a first main body portion 14 and a first extending portion 15. The first main body portion 14 is a portion extending so as to form a predetermined angle with the inclined portion 1, as in the first ground portion 10B in the first reference example described above. Specifically, the first main body portion 14 extends parallel to the horizontal plane (XY plane). The first extending portion 15 is a portion extending from the first main body portion 14 and is located between the first main body portion 14 and the inclined portion 1. Specifically, the first extending portion 15 extends downward from the end part on the +X direction side of the first main body portion 14.

In the antenna device 100D of the second modified example, the end part 18 on the inclined portion 1 side of the first main body portion 14 and the end part 19 on the inclined portion 1 side of the first extending portion 15 conducts (electrically connected) to the inclined portion 1.

The first ground portion 10D is electrically connected to the inclined portion 1 at the end parts 18 and 19, thereby suppressing the generation of the parasitic capacitance between the end part side of the first ground portion 10D and the inclined portion 1. This makes it possible to suppress the effect on the frequency band of radio waves supported by the first antenna 11D, and suppress a reduction in the gain of the first antenna 11D.

### Modified Example of First Antenna

As described above, in the antenna device 100 of an embodiment of the present disclosure, as illustrated in FIG. 2A, the first antenna 11 that supports the frequency band of ground waves is arranged on the lower side, and the second antenna 21 that supports the frequency band of satellite waves is arranged on the upper side. The second ground portion 20 is located above the first antenna 11 that is located on the lower side.

In this event, it may be difficult to ensure the element length of the first antenna 11. Further, extending the first antenna 11 may bring the first antenna 11 closer to the second ground portion 20, which may result in interference therebetween.

Thus, in the third modified example of the antenna device 100E described below, the shape of the first antenna 11E is modified, thereby being able to increase the element length of the first antenna 11E and suppress interference with the second ground portion 20.

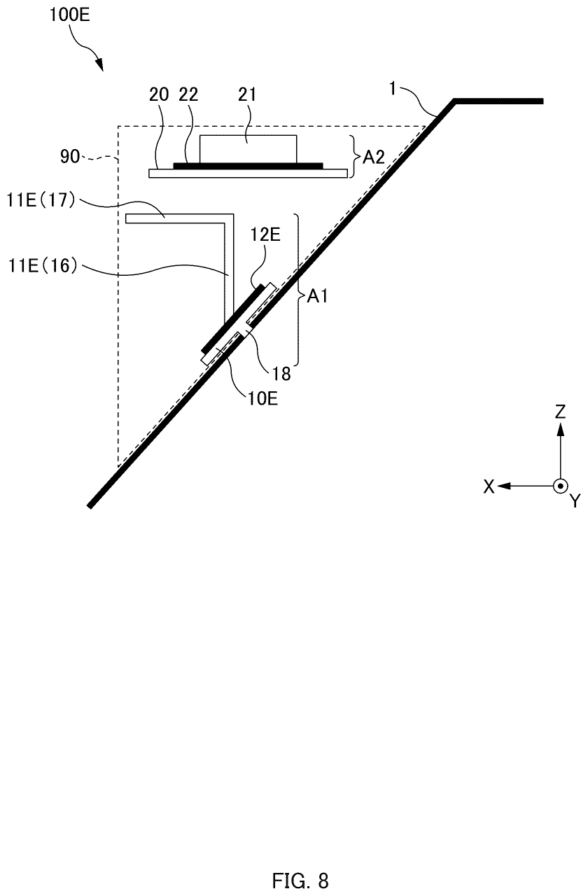

FIG. 8 is an explanatory diagram illustrating an antenna device 100E of a third modified example.

The antenna device 100E of the third modified example is arranged at the inclined portion 1, as in the antenna device 100 of an embodiment of the present disclosure. The antenna device 100E includes: the case 90; a first ground portion 10E, a first antenna 11E, and a first base portion 12E, which correspond to the first antenna unit A1; and the second ground portion 20, the second antenna 21, and the second base portion 22, which correspond to the second antenna unit A2.

In the antenna device 100E of the third modified example, the first antenna 11E includes a standing portion 16 and a facing portion 17.

The standing portion 16 is a part of the element of the first antenna 11E, the part being formed so as to stand with respect to the front surface of the first ground portion 10E. As illustrated in FIG. 8, the standing portion 16 is formed so as to stand upward (in the +Z direction). However, the standing portion 16 is not limited to standing upward, but may be inclined at a predetermined angle with respect to the upward direction. The second ground portion 20 of the second antenna unit A2 is located above the standing portion 16.

The facing portion 17 is a part of the element of the first antenna 11E, the part extending from the upper end part of the standing portion 16 and facing the back surface of the second ground portion 20. The facing portion 17 extends parallel to the back surface of the second ground portion 20. In this event, in plan view when seen from above (the +Z direction side), the tip of the facing portion 17 protrudes to the +X direction side with respect to the second ground portion 20. In other words, the second ground portion 20 and at least a part of the facing portion 17 are nonoverlapping in plan view when seen from above (the +Z direction side). In other words, the second ground portion 20 and at least a part of an element of the first antenna 11E are nonoverlapping in plan view when seen from above (the +Z direction side).

However, the facing portion 17 may be formed so as to extend from a part of the standing portion 16 other than the upper end part. That is, the facing portion 17 may be formed so as to extend from the middle in the up-down direction in the standing portion 16. Further, the direction in which the facing portion 17 extends is not limited to the direction parallel to the back surface of the second ground portion 20, but may be a direction inclined at a predetermined angle with respect to the direction parallel to the back surface of the second ground portion 20.

In the antenna device 100E of the third modified example, the first antenna 11E includes the facing portion 17, thereby being able to increase the element length of the first antenna 11E. Further, it is possible to suppress interference with the second ground portion 20.

Further, in the antenna device 100E of the third modified example, it is possible to increase the region, below the facing portion 17, in which the first ground portion 10E and the first base portion 12E are not located. That is, it is possible to increase a region in which a conductor corresponding to the thickness of the first ground portion 10E and the first base portion 12E does not exist, below the first antenna 11E (here, the facing portion 17). This makes it possible to ensure a larger distance in the Z direction from the inclined portion 1 to the first antenna 11E (here, the facing portion 17), thereby being able to increase the substantial element length of the first antenna 11E. Further, in the antenna device 100E of the third modified example, extending the first antenna 11E to the side opposite to the inclined portion 1 side makes it possible to suppress interference with the inclined portion 1.

The configuration capable of increasing the element length of the first antenna while suppressing interference with the second ground portion is not limited to the aspect of the third modified example described above.

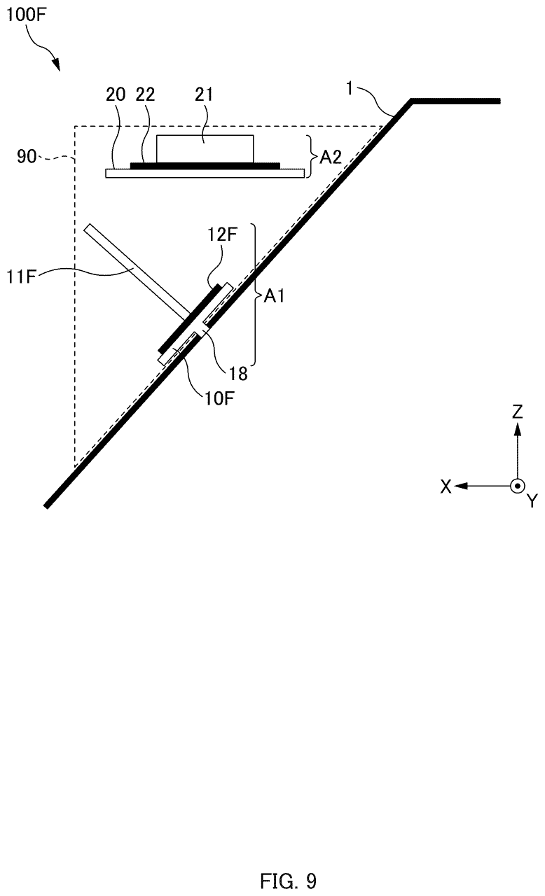

FIG. 9 is an explanatory diagram of an antenna device 100F of a fourth modified example.

The antenna device 100F of the fourth modified example is arranged at the inclined portion 1, as in the antenna device 100 of an embodiment of the present disclosure. The antenna device 100F includes: the case 90; a first ground portion 10F, a first antenna 11F, and a first base portion 12F, which correspond to the first antenna unit A1; and the second ground portion 20, the second antenna 21, and the second base portion 22, which correspond the second antenna unit A2.

In the antenna device 100F of the fourth modified example, a first antenna 11F is inclined at a predetermined angle with respect to the upward direction (+Z direction). Specifically, the first antenna 11F extends so as to be inclined toward the −X direction side with respect to the upward direction. In this event, in plan view when seen from above (the +Z direction side), the tip of the first antenna 11F protrudes to the +X direction side with respect to the second ground portion 20. That is, at least a part of the element of the first antenna 11F and the second ground portion 20 are nonoverlapping in plan view when seen from above (the +Z direction side).

In the antenna device 100F of the fourth modified example, the first antenna 11F is inclined at a predetermined angle with respect to the upward direction (+Z direction), thereby being able to extend the first antenna 11F such that the upper end part thereof and the second ground portion 20 is nonoverlapping. Thus, it is possible to increase the element length of the first antenna 11F. Further, it is possible to suppress interference with the second ground portion 20. Further, as in the antenna device 100E of the third modified example, it is possible to increase, below the first antenna 11F, a region in which the first ground portion 10F and the first base portion 12F are not located, thereby being able to increase the substantial element length of the first antenna 11F.

### Modified Example of Second Ground Portion

The following describes a modified example of the second ground portion using a comparative example. In the following explanation, illustration and explanation of the case 90, the support portion 91, and the first antenna unit A1 are omitted. Further, explanation of the same configuration as that of the antenna device 100 of an embodiment of the present disclosure may be omitted.

FIG. 10A is an explanatory diagram illustrating an antenna device 100G of a second reference example. FIG. 10B is a plan view of the antenna device 100G.

The antenna device 100G of the second reference example is arranged at the inclined portion 1, as in the antenna device 100 of an embodiment of the present disclosure. The antenna device 100G includes a second ground portion 20G, a second antenna 21G, and a second base portion 22G, which correspond to the second antenna unit A2.

The second ground portion 20G is a member that functions as a ground of the second antenna 21G that supports the frequency band of satellite waves, as in the second ground portion 20 in an embodiment of the present disclosure. As illustrated in FIG. 10B, the outer shape of the second ground portion 20G is a rectangle with different length and width, in plan view when seen from above (the +Z direction side).

The second antenna 21G is an antenna that supports the frequency band of satellite waves, as in the second antenna 21 in an embodiment of the present disclosure. As illustrated in FIG. 10A, in order to support radio waves in multiple frequency bands, the antenna device 100G employs an antenna device of the so-called stacked patch antenna type in which multiple second antennas 21G supporting radio waves in frequency bands different from each other are stacked. In the antenna device 100G, as illustrated in FIG. 10A, the second antennas 21G in two stages are stacked. Each of the second antennas 21G in two stages includes the radiating element 23 and the dielectric 24. However, the radiating element 23 of the second antenna 21G in the lower stage is hidden by the second antenna 21G in the upper stage, and thus is not illustrated.

Incidentally, the second ground portion 20G of the second antenna 21G that supports the frequency band of Satellite waves desirably has a size determined by a predetermined wavelength (hereinafter, may be referred to as “predetermined size”) so as to support the wavelength of the predetermined frequency band (hereinafter, may be referred to as “predetermined wavelength”). Here, the predetermined size is determined by the length from the center of the second antenna 21G arranged at the second ground portion 20G. When the size of the second ground portion 20G is smaller than the predetermined size, the gain of the second antenna 21G in the zenith direction may decrease.

Specifically, the second ground portion 20G desirably has the size corresponding to at least a quarter wavelength of the radio waves in the frequency band supported by the second antenna 21G from a center 29G of the second antenna 21G. Meanwhile, when the size of the entire antenna device 100G is to be reduced, the size of the second ground portion 20G needs to be reduced. When the outer shape of the second ground portion 20G is a rectangle with different length and width, for example, the gain in the zenith direction can be improved by making the length in the longitudinal direction (arrows given in FIG. 10B) of the second ground portion 20G closer to a quarter wavelength.

Further, when the outer shape of the second ground portion is rectangular, the gain and directivity in the zenith direction can be improved by locating the second antenna at the center position in the longitudinal direction of the second ground portion.

However, in the antenna device 100G of the second reference example, as illustrated in FIG. 10B, the second antenna 21G is arranged closer to the +Y direction side than to a center 28G of the second ground portion 20G. Specifically, the center 29G of the second antenna 21G is located on the +Y direction side with respect to the center 28G of the second ground portion 20G. In this event, in the second ground portion 20G in the second reference example, the gain and directivity of the second antenna 21G in the zenith direction may decrease.

Thus, as in an antenna device 100H of a fifth modified example described below, the gain and directivity of the second antenna 21H in the zenith direction can be improved by using a second ground portion 20H including a folded structure.

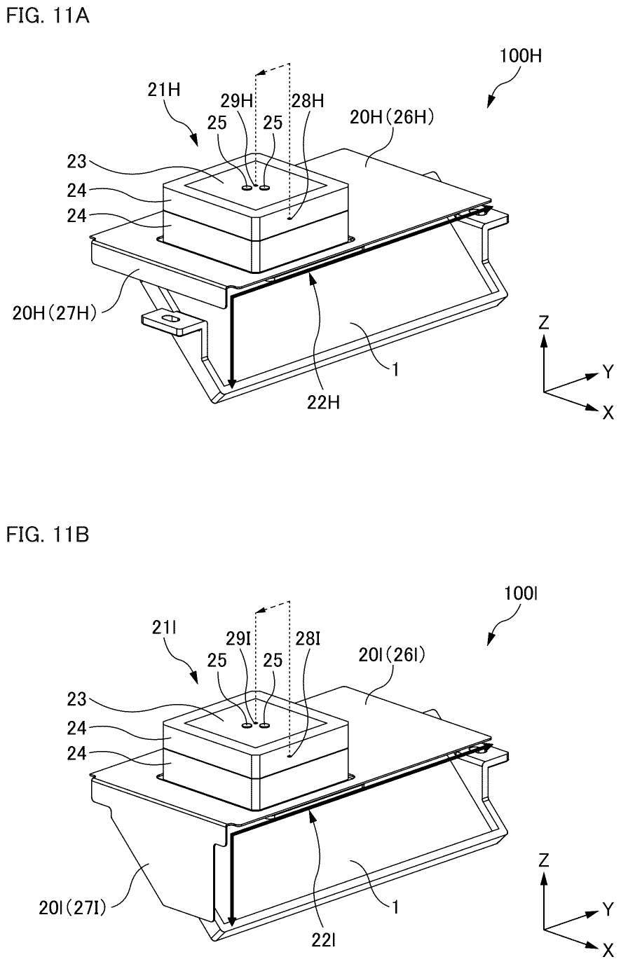

FIG. 11A is an explanatory diagram of an antenna device 100H of a fifth modified example.

The antenna device 100H of the fifth modified example is arranged at the inclined portion 1, as with the antenna device 100 of an embodiment of the present disclosure. The antenna device 100H includes the second ground portion 20H, a second antenna 21H, and a second base portion 22H, which correspond to the second antenna unit A2.

The second ground portion 20H is a member that functions as a ground of the second antenna 21H that supports the frequency band of satellite waves, as in the second ground portion 20 in an embodiment of the present disclosure. As illustrated in FIG. 11A, the second ground portion 20H includes a second main body portion 26H and a second extending portion 27H.

The second main body portion 26H is a part of the second ground portion 20H at which the second antenna 21H is arranged. The second main body portion 26H is, as with the second ground portion 20G in the second reference example described above, has a shape of a rectangle with different length and width in plan view when seen from above (the +Z direction side).

The second extending portion 27H is a part of the second ground portion 20H, the part extending from the second main body portion 26H and being located between the second main body portion 26H and the inclined portion 1. Specifically, the second extending portion 27H extends downward from the end part on the −Y direction side of the second main body portion 26H. Accordingly, as compared with the second ground portion 20G in the second reference example, the second ground portion 20H in the fifth modified example further includes the second extending portion 27H having a folded structure.

The second antenna 21H is an antenna that supports the frequency band of satellite waves, as in the second antenna 21 in an embodiment of the present disclosure. In order to support radio waves in multiple frequency bands, the antenna device 100H employs an antenna device of the so-called stacked patch antenna type in which multiple (here, two stages) second antennas 21H supporting radio waves in frequency bands different from each other are stacked.

Further, the second antennas 21H in two stages are arranged closer to the −Y direction side than to a center 28H of the second main body portion 26H. Specifically, a center 29H of each of the second antennas 21H in two stages is located on the +Y direction side with respect to the center 28H of the second main body portion 26H.

The folded structure of the second ground portion is not limited to the aspect of the fifth modified example described above.

FIG. 11B is an explanatory diagram of an antenna device 100I according to a sixth modified example.

The antenna device 100I of the sixth modified example is arranged at the inclined portion 1, as in the antenna device 100 of an embodiment of the present disclosure. The antenna device 100I includes a second ground portion 201, a second antenna 211, and a second base portion 221, which correspond to the second antenna unit A2.

The second ground portion 201 is a member that functions as a ground of the second antenna 21I that supports the frequency band of satellite waves, as with the second ground portion 20 in an embodiment of the present disclosure. The second ground portion 20I includes a second main body portion 26I and a second extending portion 27I.

The second main body portion 261 is a part, of the second ground portion 20I, at which the second antenna 21I is arranged. As with the second ground portion 20H in the fifth modified example described above, the second main body portion 261 has a shape of a rectangle with different length and width, in plan view when seen from above (the +Z direction side).

The second extending portion 27I is a part of the second ground portion 201, the part extending from the second main body portion 26I and being located between the second main body portion 26I and the inclined portion 1. Specifically, the second extending portion 27I extends downward from the end part on the −Y direction side of the second main body portion 261. The second extending portion 27I has a shape extending along the inclined portion 1, unlike the second extending portion 27H of the fifth modified example.

The second antenna 21I is an antenna that supports the frequency band of satellite waves, as with the second antenna 21 in an embodiment of the present disclosure. In order to support radio waves in multiple frequency bands, the antenna device 100I employs an antenna device of the so-called stacked patch antenna type in which multiple (here, two stages) second antennas 21I supporting radio waves in frequency bands different from each other are stacked.

Further, the second antennas 21I in two stages are arranged closer to the −Y direction side than to a center 281 of the second main body portion 261. Specifically, a center 291 of each of the second antennas 21I in two stages is located on the −Y direction side with respect to the center 28I of the second main body portion 26I.

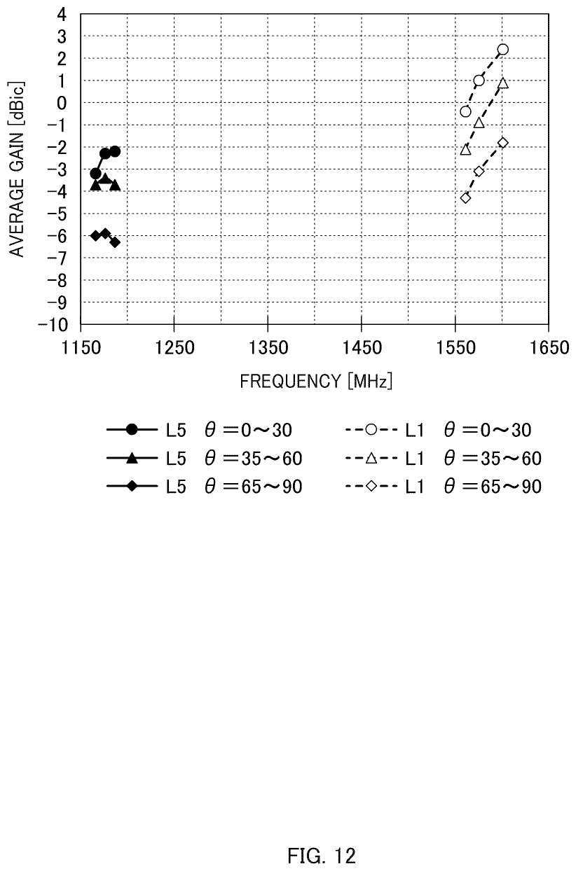

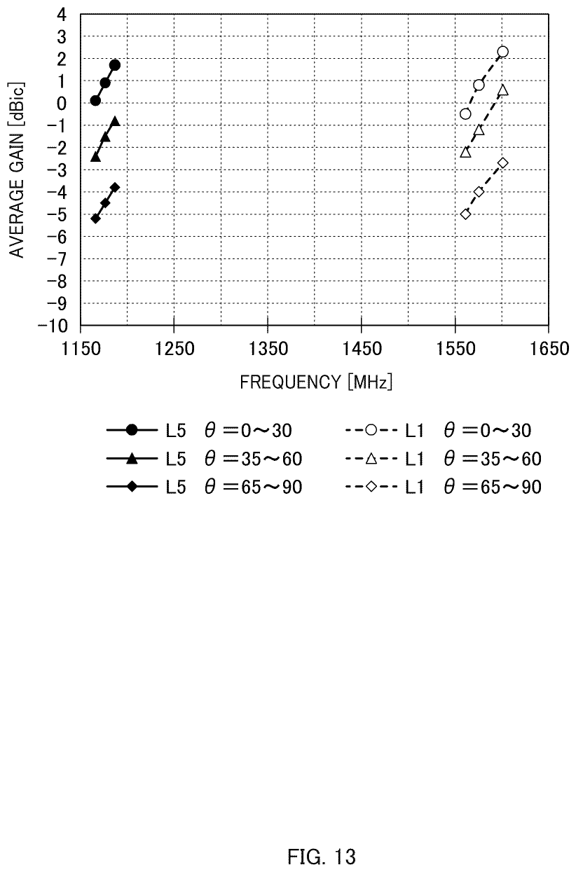

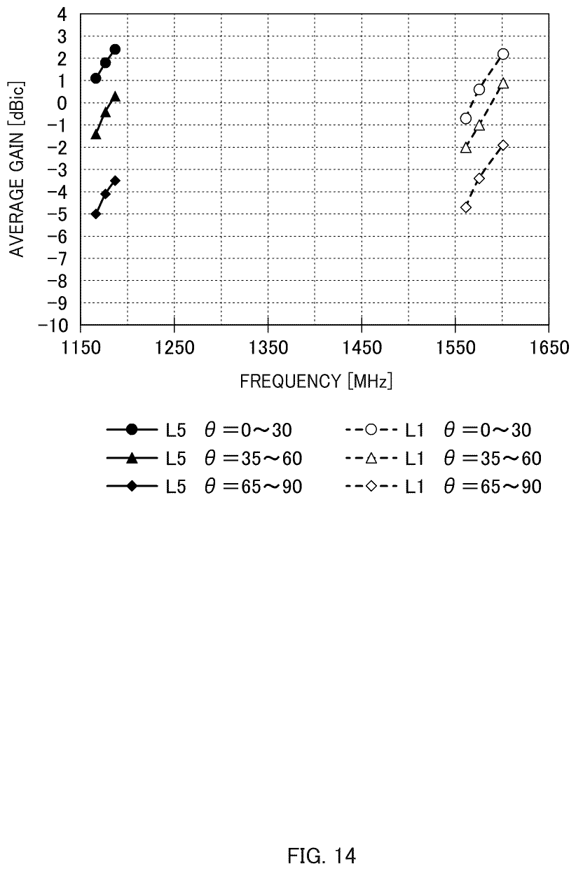

FIG. 12 is a diagram illustrating the frequency characteristics of the average gain of the second antenna 21G in the second reference example. FIG. 13 is a diagram illustrating the frequency characteristics of the average gain of the second antenna 21H in the fifth modified example. FIG. 14 is a diagram illustrating the frequency characteristics of the average gain of the second antenna 21I in the sixth modified example.

In each of the FIGS. 12 to 14, the horizontal axis represents frequency and the vertical axis represents average gain. As described above, each of the antenna devices 100G to 100I is an antenna device of the stacked patch antenna type, and supports radio waves in frequency bands different from each other. In each of the FIGS. 12 to 14, the results for the second antenna that supports radio waves in the L1 band and the second antenna that supports radio waves in the L5 band are given by a dashed line and a solid line, respectively.

Furthermore, in each of the FIGS. 12 to 14, the value of the average gain at each angle θ is plotted using marks. Here, the angle θ is an angle formed by the angle at which the average gain is calculated with the +Z direction, where θ=0. That is, in each of the FIGS. 12 to 14, the mark ○ (open circle) on the dashed line and the mark ● (filled circle) on the solid line represent the results when the angle θ is from 0 degrees to 30 degrees. Further, the mark Δ (white triangle) on the dashed line and the mark ▴ (black triangle) on the solid line represent the results when the angle θ is from 35 degrees to 60 degrees. Furthermore, the mark ⋄ (white diamond) on the dashed line and the mark ♦ (black diamond) on the solid line represent the results when the angle θ is from 65 degrees to 90 degrees.

As illustrated in FIGS. 12 to 14, it can be seen that the second antenna 21H arranged at the second ground portion 20H including a folded structure has an improved average gain, particularly in the frequency band of the L5 band, as compared to the second antenna 21G arranged at the second ground portion 20G not including a folded structure. It can also be seen that the second antenna 21I arranged at the second ground portion 201 has an improved average gain, particularly in the frequency band of the L5 band, as compared to the second antenna 21H arranged at the second ground portion 20H.

Accordingly, with a folded structure, the length of the second ground portion in the longitudinal direction can be made close to a quarter wavelength within a limited accommodation space, thereby being able to improve the gain in the zenith direction.

### Other Modified Examples

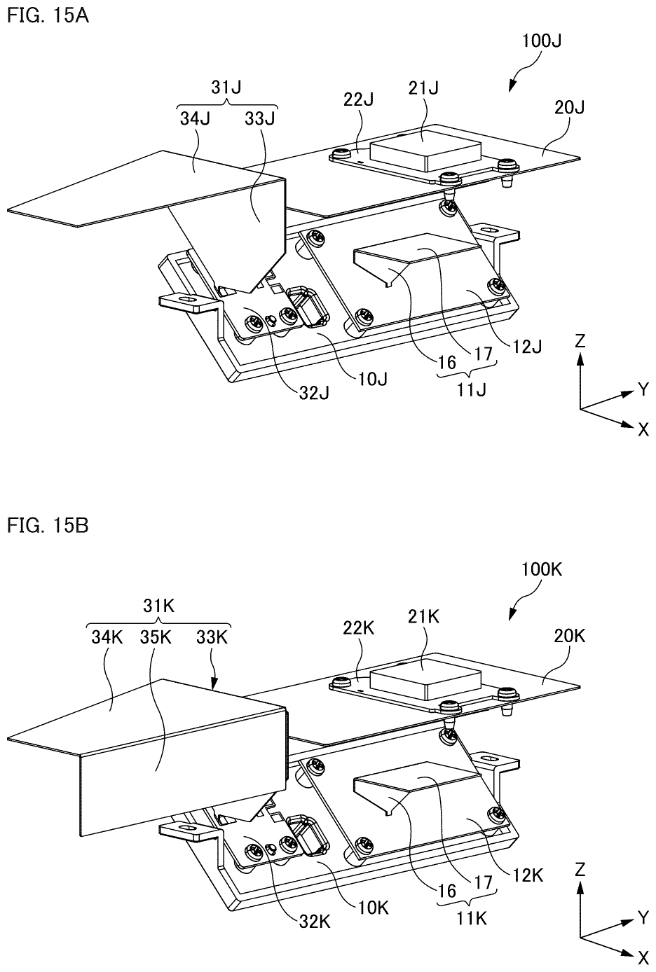

FIG. 15A is an explanatory diagram illustrating an antenna device 100J of f a seventh modified example. In the following explanation, illustration and explanation of the case 90 and the support portion 91 are omitted. Further, explanation of the same configuration as that of the antenna device 100 of an embodiment of the present disclosure may be omitted.

The antenna device 100J of the seventh modified example is arranged at an inclined portion (not illustrated), as with the antenna device 100 of an embodiment of the present disclosure. The antenna device 100J includes: a first ground portion 10J, a first antenna 11J, and a first base portion 12J, which correspond to the first antenna unit A1; and a second ground portion 20J, a second antenna 21J, and a second base portion 22J, which correspond to the second antenna unit A2.

In the antenna device 100 of an embodiment of the present disclosure described above, the first antenna 11 of the first antenna unit A1 is arranged on the lower side of the inclined portion 1, and the second antenna 21 of the second antenna unit A2 is arranged on the upper side thereof. The antenna device 100J of the seventh modified example may further include another antenna. The antenna device 100J further includes a third antenna 31J and a third base portion 32J, on the −Y direction side with respect to the first antenna 11J and the second antenna 21J.

In the antenna device 100J of the seventh modified example, the first ground portion 10J functions as a ground common to the first antenna 11J and the third antenna 31J. However, the antenna device 100J may further include a ground portion that functions as a ground of the third antenna 31J, and may be electrically connected to the first ground portion 10J.

The third antenna 31J is an antenna that supports a frequency band of ground waves. The third antenna 31J supports radio waves in a frequency band for telephone (TEL) used for GSM, UMTS, LTE, 5G, and/or the like, for example. However, the third antenna 31J may support radio waves in a frequency band used for telematics, V2X, Wi-Fi, Bluetooth, and/or the like.

The third antenna 31J is a planar antenna. Here, the term “planar antenna” refers to an antenna whose elements are formed mainly of a plate-shaped members. The third antenna 31J is a so-called planar inverted-L antenna. However, not all of the antenna elements need to be formed of a plate-shaped member, but the antenna elements may have a portion formed of one other than a plate-shaped member. Further, the “planar antenna” has a shape with a predetermined width.

The third antenna 31J includes a vertical plate portion 33J and a horizontal plate portion 34J.

The vertical plate portion 33J is a part of the element of the third antenna 31J, the part being formed so as to stand with respect to the front surface of the first ground portion 10J. As illustrated in FIG. 15A, the vertical plate portion 33J is formed so as to stand in the upward direction (in the +Z direction). However, the vertical plate portion 33J is not limited to standing in the upward direction, but may be inclined at a predetermined angle with respect to the upward direction.

The horizontal plate portion 34J is a part of the element of the third antenna 31J, the part extending in the horizontal direction from the upper end part of the vertical plate portion 33J. However, the horizontal plate portion 34J may be formed so as to extend from a part other than the upper end part of the vertical plate portion 33J. That is, the horizontal plate portion 34J may be formed so as to extend from the middle of the vertical plate portion 33J in the up-down direction. Further, the direction in which the horizontal plate portion 34J extends is not limited to the horizontal direction, but may be a direction inclined at a predetermined angle from the horizontal direction.

FIG. 15B is an explanatory diagram of an antenna device 100K according to an eighth modified example.

The antenna device 100K of the eighth modified example is arranged at the inclined portion 1, as with the antenna device 100 of an embodiment of the present disclosure. The antenna device 100K includes: a first ground portion 10K, a first antenna 11K, and a first base portion 12K, which correspond to the first antenna unit A1; and a second ground portion 20K, a second antenna 21K, and a second base portion 22K, which correspond to the second antenna unit A2.

The antenna device 100K further includes a third antenna 31K and a third base portion 32K, as with the antenna device 100J of the seventh modified example described above. The third antenna 31K includes a vertical plate portion 33K, a horizontal plate portion 34K, and an additional portion 35K.

The vertical plate portion 33K and the horizontal plate portion 34K are the same as or similar to the vertical plate portion 33J and the horizontal plate portion 34J in the seventh modified example, respectively. The additional portion 35K is an additional portion of the element connected to the horizontal plate portion 34K. The additional portion 35K is located on the side (the −X direction side) opposite to inclined portion 1 with respect to the horizontal plate portion 34K.

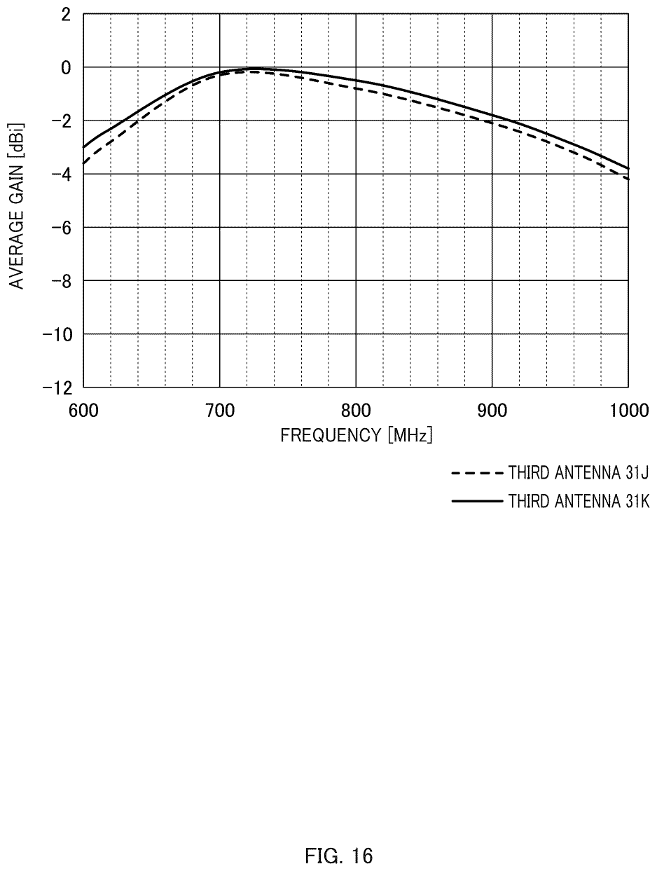

FIG. 16 is a diagram illustrating frequency characteristics of the average gains of the third antenna 31J and the third antenna 31K.

In FIG. 16, the horizontal axis represents frequency and the vertical axis represents average gain. The results of the third antenna 31J of the seventh modified example described above are given by a dashed line, and the results of the third antenna 31K of the eighth modified example described above are given by a solid line.

As illustrated in FIG. 16, it can be seen that the average gain of the third antenna 31K is improved by virtue of the third antenna 31K including the additional portion 35K. This is because the capacity increases, thereby being able to obtain broadband characteristics, by virtue of the third antenna 31K including the additional portion 35K. Further, it is possible to obtain more broadband characteristics, by virtue of the additional portion 35K being positioned on the side (the +X direction side) opposite to the inclined portion 1 with respect to the horizontal plate portion 34K.

FIG. 17 is an explanatory diagram of an antenna device 100L of a ninth modified example. In the following explanation, illustration and explanation of the case 90, the support portion 91, and the first antenna unit A1 are omitted. Further, explanation of the same configuration as that of the antenna device 100 of an embodiment of the present disclosure may be omitted.

The antenna device 100L of the ninth modified example is arranged at the inclined portion 1, as with the antenna device 100 of an embodiment of the present disclosure. The antenna device 100L includes: a second ground portion 20L, a second antenna 21L, and a second base portion 22L, which correspond to the second antenna unit A2; a fourth antenna 41; and a fourth base portion 42.

The fourth antenna 41 supports radio waves in a frequency band used for V2X, for example. The fourth base portion 42 is a member at which the feeding portion and the matching circuit of the fourth antenna 41 are located. In the antenna device 100L of the ninth modified example, the fourth antenna 41 and the fourth base portion 42 are arranged at the second ground portion 20L serving as a common ground.

FIG. 18 is an explanatory diagram illustrating an antenna device 100M of a tenth modified example.

The antenna device 100M of the tenth modified example is arranged at the inclined portion 1, as with the antenna device 100 of an embodiment of the present disclosure. The antenna device 100M includes: a second ground portion 20M, a second antenna 21M, and a second base portion 22M, which correspond to the second antenna unit A2; and a fifth antenna 51.

The fifth antenna 51 supports radio waves in the frequency band for TEL used for GSM, UMTS, LTE, 5G, and/or the like, for example. In the antenna device 100M of the tenth modified example, the fifth antenna 51 is arranged at the second ground portion 20M serving as a common ground.

Embodiments and modified examples of the present disclosure have been described above with reference to the drawings, but these are just examples of the present disclosure, and various configurations other than those described above may be employed.

### Summary

According to the present Description, an antenna device of aspects described below is provided.

### Aspect 1

In Aspect 1, the antenna device including: the first ground portion 10 located on the upper side with respect to the inclined portion 1 that is inclined with respect to the horizontal plane; the first antenna 11 that is arranged on the front surface side of the first ground portion 10, and that supports the first frequency band of ground waves; the second ground portion 20 that is located on the upper side with respect to the inclined portion, and that has the front surface parallel to the horizontal plane; and the second antenna 21 that is arranged on the front surface side of the second ground portion 20, and that supports the second frequency band of satellite waves, the first ground portion 10 and the first antenna 11 being located on the lower side with respect to the second ground portion 20.

According to an aspect described above, in the inclined portion 1, each of the plurality of antennas can be efficiently arranged within a limited accommodation space while ensuring the desired characteristics.

### Aspect 2

In Aspect 2, the inclined portion 1 includes a conductive part, and the first ground portion 10 is formed so as to suppress unwanted resonance in the first frequency band.

According to an aspect described above, it is possible to suppress a decrease in the gain of the first antenna 11.

### Aspect 3

In Aspect 3, the first ground portion 10 is arranged parallel to the upper surface of the inclined portion 1.

According to an aspect described above, it is possible to suppress a decrease in the gain of the first antenna 11.

### Aspect 4

In Aspect 4, the first ground portion 10C extends so as to form a predetermined angle with the inclined portion 1, and the first ground portion 10C includes, on the back surface side thereof, the suppression portion that suppresses unwanted resonance in the first frequency band.

According to an aspect described above, it is possible to suppress a decrease in the gain of the first antenna 11C.

### Aspect 5

In Aspect 5, the first ground portion 10D includes the first main body portion 14 extending to form a predetermined angle with the inclined portion 1, and the first extending portion 15 that extends from the first main body portion 14, and that is located between the first main body portion 14 and the inclined portion 1, and the end part 18 of the first main body portion 14 on the inclined portion 1 side and the end part 19 of the first extending portion 15 on the inclined portion 1 side are electrically connected to the inclined portion 1.

According to an aspect described above, it is possible to suppress a decrease in the gain of the first antenna 11D.

### Aspect 6

In Aspect 6, in plan view when seen from above, the second ground portion 20 and at least a part of an element of the first antenna 11E are nonoverlapping.

According to the above-described aspect, it is possible to increase the element length of the first antenna 11E, and suppress interference with the second ground portion 20.

### Aspect 7

In Aspect 7, the antenna device includes the support portion 91 that supports the second ground portion 20 with respect to the inclined portion 1, the support portion 1 being formed of an insulator, the inclined portion 1 including a conductive part,

According to an aspect described above, it is possible to improve the gain and directivity of the second antenna 21 in the zenith direction.

### Aspect 8

In Aspect 8, the second ground portion 20H includes the second main body portion 26H where the second antenna 21H is arranged, the second main body portion 26H extending in the direction parallel to the horizontal plane, and the second extending portion 27H that extends from the second main body portion 26H, and that is located between the second main body portion 26H and the inclined portion 1.

According to an aspect described above, it is possible to improve the gain and directivity of the second antenna 21 in the zenith direction.

### Aspect 9

In Aspect 9, the center of the second antenna 21H is located on the side in the predetermined direction with respect to the center of the second main body portion 26H, and the second extending portion 27H extends from the end part of the second main body portion 26H on the side in the predetermined direction.

According to an aspect described above, it is possible to improve the gain and directivity of the second antenna 21 in the zenith direction.

### Aspect 10

In Aspect 10, the antenna device 100 is arranged at a vehicle.

According to an aspect described above, it is possible to efficiently arrange a plurality of antennas at the inclined portion 1 of a vehicle within a limited accommodation space, while ensuring the desired characteristics of each of the antennas.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

### REFERENCE SIGNS LIST

1 inclined portion
10, 10B to 10F, 10J, 10K first ground portion
11, 11b to 11F, 11J, 11K first antenna
13 suppression portion
14 main body portion
15 first extending portion
18, 19 end part
20, 20A, 20G to 20M second ground portion
21, 21A, 21G to 21M second antenna
26H, 26I second main body portion
27H, 27I second extending portion
28G to 28I, 29G to 29I center
91 support portion
100, 100A to 100M antenna device

1. An antenna device, comprising:
a first ground portion located on an upper side with respect to an inclined portion that is inclined with respect to a horizontal plane;
a first antenna that is arranged on a front surface side of the first ground portion, and that supports a first frequency band of ground waves;
a second ground portion that is located on the upper side with respect to the inclined portion, and that has a front surface parallel to the horizontal plane; and
a second antenna that is arranged on a front surface side of the second ground portion, and that supports a second frequency band of satellite waves,
the first ground portion and the first antenna being located on a lower side with respect to the second ground portion.

2. The antenna device according to claim 1, wherein
the inclined portion includes a conductive part, and
the first ground portion is formed so as to suppress unwanted resonance in the first frequency band.

3. The antenna device according to claim 1, wherein
the first ground portion is arranged parallel to an upper surface of the inclined portion.

4. The antenna device according to claim 1, wherein
the first ground portion extends so as to form a predetermined angle with the inclined portion, and
the first ground portion includes, on a back surface side thereof, a suppression portion that suppresses unwanted resonance in the first frequency band.

5. The antenna device according to claim 1, wherein
the first ground portion includes
a first main body portion extending to form a predetermined angle with the inclined portion, and
a first extending portion that extends from the first main body portion, and that is located between the first main body portion and the inclined portion, and
an end part of the first main body portion on the inclined portion side and an end part of the first extending portion on the inclined portion side are electrically connected to the inclined portion.

6. The antenna device according to claim 1, wherein
in plan view when seen from above, the second ground portion and at least a part of an element of the first antenna are nonoverlapping.

7. The antenna device according to claim 1, further comprising:
a support portion that supports the second ground portion with respect to the inclined portion,
the support portion being formed of an insulator,
the inclined portion including a conductive part.

8. The antenna device according to claim 1, wherein
the second ground portion includes
a second main body portion where the second antenna is arranged, the second main body portion extending in a direction parallel to the horizontal plane, and
a second extending portion that extends from the second main body portion, and that is located between the second main body portion and the inclined portion.

9. The antenna device according to claim 8, wherein
a center of the second antenna is located on a side in a predetermined direction with respect to a center of the second main body portion, and
the second extending portion extends from an end part of the second main body portion on the side in the predetermined direction.

10. The antenna device according to claim 1, wherein
the antenna device is arranged at a vehicle.
